(19) United States
(12) Patent Application Publication
(10) Pub. No.: US 2018/0320114 A1
(43) Pub. Date: Nov. 8, 2018

(54) HIGHLY-ACTIVE THREE-PHASE HEAVY-DUTY DETERGENT CLOTH AND METHOD FOR THE PRODUCTION THEREOF

(71) Applicant: COIN CONSULTING GMBH, Menden (DE)

(72) Inventor: Michael Pulina, Krefeld (DE)

(73) Assignee: COIN CONSULTING GMBH, Menden (DE)

(21) Appl. No.: 15/771,042

(22) PCT Filed: Oct. 31, 2016
(86) PCT No.: PCT/EP2016/076224

§ 371 Date: Apr. 25, 2018

(30) Foreign Application Priority Data
Oct. 30, 2015 (DE) 10 2015 014 015.9

(51) Int. Cl. C11D 17/04; C11D 3/12; D06B 1/12

(52) U.S. Cl. CPC C11D 17/049; C11D 3/128; D06M 11/77; D06B 1/12; C11D 3/1266

(57) ABSTRACT

The present invention discloses a three-phase heavy-duty laundry detergent wipe, a system comprising a three-phase heavy-duty laundry detergent wipe and a moistening device for manufacturing same and a method for manufacturing a three-phase heavy-duty laundry detergent wipe, wherein a dispersion (3) is applied to carrier material (4) which is solid at ambient temperature, characterized by the following steps: (a) providing a liquid laundry detergent lotion (1) with exothermically saponified components and a water content of 10-30 weight %; (b) adding solid additives (2) to the liquid laundry detergent lotion (1) using a disperser such that the dispersion (3)is created with a solid content of 1-10 weight %; (c) applying the dispersion to the carrier material (4) with a moistening device (5) such that the carrier material (4) statistically fixes the dispersion (3); wherein steps (a)-(c) are performed at ambient temperature and wherein the ratio between the average particle size of the solid additives (2) and the diameter and gap width, resp., of the openings of the moistening device (5) ranges between 5*10⁻⁴:1 and 15*10⁻⁴:1.

### FIELD OF THE INVENTION

The present invention is directed to a laundry detergent wipe and to a method for manufacturing same and, in particular, to a highly active three-phase heavy-duty laundry detergent wipe with sustainability features and a method for manufacturing same.

### BACKGROUND OF THE INVENTION AND PRIOR ART

The pursuit of hygiene exists from the beginning of mankind. Hygiene eventually is an important aspect of everyday life. The hygienic approach primarily consists in maintaining the health. In addition to the general cleaning effects scent and improved cleaning power of the raw material compositions have also come under scrutiny due to extended possibilities. Cleaning power optimization is particularly characterized by the ability to extend a hygienically clean state and an improvement of the degree of cleaning.

Nowadays hygiene can be divided into the fields of body, surface and textile hygiene. The latter is divided into applications depending on textile material and color. At least since the Nineties of the 20^{th} century the consumer's awareness has been raised of ecological cleaning. In this regard, it is desirable to maintain the advantages of conventional washing detergents, on the one hand, and to find further innovative and ecologically feasible product solutions, on the other hand.

With the beginning of industrial production, laundry detergents have been realized as powders. This very day, a powder laundry detergent consists of a mixture of different washing active substances.

With the progress during the development of laundry detergents enzymes and other new surfactant compositions entered this market segment. In addition to the substances necessary for cleaning large amounts of filler material are added nowadays. Accordingly, no change of the consumer's dosing behavior was necessary. First attempts to omit filler material resulted in an overdosing of the surfactants due to the application the users were used to.

Then liquid washing detergents were introduced which could be dosed residue-free and, thus, offered a physical alternative to the mixture of solids of laundry detergents. However, up to now liquid washing detergents do not accomplish the cleaning level of a heavy-duty laundry detergent (i.e., a mixture of solids). This is due to the fact that a liquid washing detergent is limited to liquid components or components which are well soluble in water. The essential substances missing in a liquid washing detergent are the zeolites. The latter support dirt adsorption and brightening/color fastness during the application.

A current product trend is the way of portioning the washing detergent. This can be achieved, on the one hand, by packing a liquid washing detergent in small polymer pouches. However, the problem of the missing zeolite mentioned above still persists. Another physical modification of the washing detergent consists in mixing a washing detergent with a fatly alcohol in order to achieve desired forms. Both product concepts, however, describe a one-phase product which can only be differentiated by way of its portioning.

As disclosed in DE 10 2010 060 126 A1, a multi-phase product can be provided. The laundry detergent wipe disclosed therein is characterized by combining a carrier material with an impregnating liquid (two-phase product). However, in this case the disadvantage of the missing zeolite still persists.

DE 10 2013 014 015 by the applicant discloses a central advancement in the form of a three-phase heavy-duty laundry detergent wipe, consisting of a dispersion (i.e., a liquid continuous phase with solid components) and a solid substrate, wherein the dispersion is applied to a carrier material which is solid at ambient temperature. The carrier material can be a non-woven, a fat alcohol or a substrate for the phase combination of a dispersion with an additional separate phase. The first phase of the dispersion thus is a liquid detergent concentrate, consisting of washing active substances, enzymes, and, where necessary, bleaching agents; the second phase of the dispersion is a builder and a substance for supporting dirt absorption, resp., (e.g. a zeolite) in solid modification; the third phase is a substrate which is solid at ambient temperature and to which the mixture of the first and second phases is applied, wherein the substrate can consist of, e.g., viscose, polyethylene, polypropylene or polyester. The solid phase of the dispersion, i.e., the second phase, is a functional component of the heavy duty detergent. The substrate is used for the statistical fixation of the dispersion and consists of a raw material which is solid at ambient temperature. Furthermore, all known components of a heavy duty laundry detergent can be included. Due to the multiple mixing of the phases into a three-phase heavy-duty laundry detergent wipe, it is possible to use a builder which is insoluble in water in a liquid detergent and to achieve the necessary statistically stable uniform distribution. Exploiting the full performance and, in particular, the sustainability of this product, however, requires an enhanced method for producing the three-phase heavy-duty laundry detergent wipe in view of the dispersion and the active substances contained therein.

Accordingly, the problem to be solved by the present invention was to provide a three-phase heavy-duty laundry detergent wipe and a method for manufacturing same with enhanced sustainability features.

### SUMMARY OF THE INVENTION

It is object of the present invention to provide a three-phase heavy-duty laundry detergent wipe with enhanced sustainability features not only in its composition but also in its manufacturing.

This object has been achieved by a method for manufacturing a three-phase heavy-duty laundry detergent wipe according to claim 1, wherein a dispersion (3) is applied to a carrier material (4) which is solid at ambient temperature, characterized by the following steps: (a) providing a liquid laundry detergent lotion (1) with exothermically saponified components and a water content of 10-30 weight %; (b) adding solid additives (2) to the liquid laundry detergent lotion (1) using a disperser such that the dispersion (3) is created with a solid content of 1-10 weight %; (c) applying the dispersion to the carrier material (4) with a moistening device (5) such that the carrier material (4) statistically fixes the dispersion (3); wherein steps (a)-(c) are performed at ambient temperature and wherein the ratio between the average particle size of the solid additives (2) and the diameter and gap width, resp., of the openings of the moistening device (5) ranges between 5*10⁻⁴:1 and 15*10⁻⁴:1.

This object has further been achieved by a three-phase heavy-duty laundry detergent wipe according to claim 10, and a system comprisng a wipe and a moistening device for manufacturing same according to claim 18.

Advantageous embodiments of the method and the three-phase heavy-duty laundry detergent wipe are disclosed in the dependent claims.

The term “laundry detergent lotion” means, according to the invention, a composition comprising one or more biocatalysts, preferably enzymes or cell extracts, in particular, enzymes suitable for manufacturing laundry or cleaning detergents. Thus, the three-phase heavy-duty laundry detergent wipe according to the invention also contains one or more functional intact biocatalysts in its composition, in particular, enzymes.

The term “ambient temperature” means, according to the invention, a temperature range where biocatalysts are not inactivated irreversibly, preferably approx. 5-50° C., in particular preferably approx., 15-30° C.

According to the invention, the term “weight %” means, if not otherwise indicated, weight % (w/w).

The term “dispersion” means, according to the invention, preferably a suspension, in particular preferably a suspension with a liquid phase as the continuous phase.

The term “exothermically saponified components” means, according to the invention, exothermically saponified or neutralized molecule parts, in particular exothermically saponified or neutralized fatty acid residues.

The term “average particle size” means, according to the invention, the mean particle size D₅₀ with regard to the arithmetic mean and can be determined, e.g., by a laser diffractometer “Mastersizer™ 2000S” from Malvern Instruments Ltd., (Malvern, Worcestershire, United Kingdom) according to ISO 13320:2009 (cf., e.g., document ID 7.1.1.2.ac133,E from PQ Corporation (Valleybrooke Corporate Center, Malvem, Pa. 19355-1740, U.S.A.)).

### DESCRIPTION OF THE PREFERRED EMBODIMENTS

The notion of sustainability is currently being discussed controversially also in the sciences, such that it is reasonable to define this aspect in regard to each field of application via specific sustainability features. For laundry detergents central sustainability features result from resource protection, distribution (CO₂ balance), application by the consumer (dosing) and energy balance during manufacturing. Transformed to technical features, this means that a light and compact washing detergent should be provided which can be produced in a cold process. Thus, the aim of the present invention can be derived from the sustainability features described below.

Ressource Protection

Hitherto existing forms of laundry detergents can be divided into the groups of powders, liquid laundry detergents and pre-dose laundry detergents (such as laundry sheets/boards and polmyer pouches filled with liquid laundry detergents). The composition of the powders is characterized in that one part thereof consists in sodium sulfate and similar substances used for enhancing the pourability—these materials do not have any function in regard to the washing activity. On the other hand, liquid laundry detergents contain a considerable amount of water because of the desired viscosity, flowability and, thus, easy dosability. Pre-dose laundry detergents in the form of polymer pouches filled with liquid laundry detergents usually have a high water and solutizer (polypropylene glycol, glycerin), resp., content and the polymer (e.g. a polyvinyl alcohol), both of which are (by way of a dissolving process) disposed with the laundry water into the waste water, whereas the laundry sheet/board contains a considerable amount of fatty alcohols and similar materials used for forming the sheet/board via smelting. The quantitative amounts of the respective non-washing active components are summarized in Table 1.

TABLE 1
Average portions of non-washing active components in weight %

| | | Liquid | Polymer | Laundry |
|---|---|---|---|---|
| | Powder | detergent | pouch | sheet/board |
| Filler/trickling medium | 20% | — | — | — |
| (e.g. Na₂SO₄) | | | | |
| Water | — | 50% | — | — |
| Solutizer | — | — | 15% | — |
| Polymer | — | — | 10% | — |
| Molding material | — | — | — | 50% |
| (e.g. fatty alcohols) | | | | |

In contrast thereto, resource protection should consist in providing a laundry detergent having the highest possible degree of washing active components and no, or only a small amount of, additives such as the ones mentioned in Table 1 above since filler and trickling media or molding materials are not required as far as the core laundry requirements are concerned.

Distribution (CO₂ Balance)

The CO₂ balance, which is dependent on the technical parameters of the respective laundry detergent, is based on the physical units volume and mass. The laundry detergent volumes for an average laundry cycle (laundry load) for standard laundry detergents are shown in Table 2.

TABLE 2
Average volumes of laundry detergent forms per laundry load

| | | Liquid | | Laundry |
|---|---|---|---|---|
| | Powder | detergent | Polymer pouch | sheet/board |
| Volume (mL) | 80 | 75 | 32 | 25 |

In order to arrive at a low CO₂ balance, the volume per laundry cycle should be kept as small as possible.

Application by the Consumer (Dosing)

During the development of laundry detergents, laundry detergent concentrates have also been introduced. However, they were not accepted by the consumers because the price level per washing load was considerably higher due to frequent overdosing. This means that the consumer obviously adopts learned behavioral patterns. On the average, an overdosing of 7% can be assumed in the field of laundry powders and liquid detergents. In this regard, the application forms of pre-dose laundry detergents are an advantage because environmental pollution due to wrong dosing can largely be avoided.

Energy Balance During Production

A full energy balance is always directly correlated to the edcuts used. In connection with the value added during production, the two groups of hot processes and cold processes can be distinguished. In view of the energy balance, it is recommendable to use a cold process during production of the laundry detergent. This is only the case for liquid laundry detergents which, however, have a considerably lower cleaning performance due to the absence of, e.g., zeolites mentioned above since solid components cannot be incorporated. Laundry powders and laundry sheets/boards allowing the incorporation of solid components as well as polymer pouches filled with liquid laundry detergents are manufactured in a hot process. Accordingly, all known laundry detergents comprising a solid such as zeolite have to be manufactured in a hot process. The manufacturing of laundry powders in the art can be performed in two ways. Either, a high pressure spraying process is used, wherein a slurry, mixed before from temperature resistant components of a laundry detergent, is dried at 110-130° C. in a spray tower in a hot counter flow, whereupon temperature sensitive components are added. This process is shown in Chart 1.

CHART 1
Manufacturing of powder laundry detergent (first process)

| | Slurry production | Spray tower | Mixture |
|---|---|---|---|
| Temperature | Ambient temperature | 110-300° C. | Ambient temperature |
| Aggregates | Mixture solid and liquid | Solid | Solid |
| | (two-phase mixture) | (one-phase product) | (one-phase product) |
| Production feature | Mixture (via stirring) from | Spray drying in hot | Addition of temperature |
| | temperature resistant | counter flow | sensitive components (e.g., |
| | components of the laundry | (pressure approx. 40-70 bar) | enzymes, bleaching |
| | detergent | | agents, scents) |
| Product feature | Slurry | Powder | Powder |

The second way of manufacturing powder laundry detergents is performed using an extruder for pre-mixing a paste at 80-110° C., whereupon fitted cylinders are formed into balls in a rounding device also at 80-110° C., whereupon temperature sensitive components are added again like in the first process. This second process is shown in Chart 2.

CHART 2
Manufacturing of powder laundry detergent (second process)

| | Production extruder mixture | Rounding device | Mixture |
|---|---|---|---|
| Temperature | 80-110° C. | 80-110° C. | Ambient temperature |
| Aggregates | Mixture of solid and liquid | Solid | Solid |
| | (two-phase mixture) | (one-phase product) | (one-phase product) |
| Production feature | Pre-mixture from | Fitted cylinders are | Addition of |
| | temperature resistant | formed into balls, | temperature sensitive |
| | components of the laundry | followed by cooling to | components (e.g., |
| | detergent via extruder | 30° C. | enzymes, bleaching |
| | | | agents, scents) |
| Product feature | Slurry/paste | Powder | Powder |

In view of the sustainability features mentioned above, the object of the present invention was the development of a highly active pre-dose laundry detergent (sustainability feature of application by the consumer) which can be manufactured in a cold process (sustainability feature of energy balance during production) and which has a maximized content of washing active substances (sustainability feature of resource protection) at small mass and volume values sustainability feature of distribution).

Surprisingly, this object could be achieved by manufacturing a three-phase heavy-duty laundry wipe, comprising
1. a liquid laundry detergent lotion 1 with a low content of non-washing active substances,
2. an incorporated solid 2 for enhancing the washing active performance and
3. a hydrophobic carrier material 4 comprising a polymer (comprising a monomer) in the form of a continuous filament, in a cold process.

Table 3 shows an exemplary formulation 1 which was produced in a first method step and which can successfully be used for the cold production of a three-phase heavy-duty laundry detergent wipe.

TABLE 3
Water content/composition of the lotion for the three-phase
heavy-duty laudry detergent wipe in weight %

| Raw material | Amount |
|---|---|
| Water | 10-30% |
| Anionic tensides, nonionic tensides, phosphonates, complexing | 70-90% |
| agents, C10-C18 fatty acid salts, optical brighteners, stabilizers | |
| (propylene glycol, glycerin, inbulin), scents, preserving agents, | |
| soil release polymer, pH regulators and further active substances | |
| (e.g., color transfer protection, hydrotropic agents, | |
| opacifiers etc.) | |

In a second process step, a solid content 2 of 1-10 weight % is incorporated into the lotion 1 by stirring and/or dispersing to obtain a dispersion 3. No heat was introduced in this step, either. The solid contained therein (zeolites, phyllosilicates and their derivates) is a further washing active component.

In a third process step, the dispersion 3 manufactured according to the above is applied to a carrier material 4. The process for manufacturing the inventive three-phase heavy-duty laundry detergent wipe is shown in Chart 3 and will be explained in more detail below.

CHART 3
Production of the three-phase heavy-duty laundry detergent wipe (entries in weight %)

| | Lotion production | Dispersion | Moistening |
|---|---|---|---|
| Temperature | Ambient temperature | Ambient temperature | Ambient temperature |
| Aggregate | Liquid lotion | Addition of solid additive | Carrier material (e.g. |
| | (one-phase product) | (e.g. zeolite, phyllosilicates | polypropylene from |
| | | or their derivates) in liquid | continuous filament) is |
| | | lotion (two-phase product) | moistened with |
| | | | dispersion (three-phase |
| | | | product) |
| Production feature | Exothermic saponification | Use of a dispergator | Device for moistening, |
| | | | cutting and folding the |
| | | | three-phase laundry |
| | | | wipe |
| Product feature | Lotion with water content | Lotion with water content | Lotion with water |
| | of approx. 25% | of approx. 25% with 5% | content of approx. 25% |
| | | solid content | with 5% solid content |
| | | | on solid substrate |

As can be seen, the method can be performed at ambient temperature throughout. First, a liquid laundry detergent lotion with exothermically saponified components and a water content of 25 weight % is produced, wherein the water content can also be higher or lower and generally range between 10-30 weight %.

Then solid additives 2 such as, zeolites, phyllosilicates etc. are added to the lotion 1 using a dispergator to create a dispersion 3, wherein the solid content of the dispersion 3 is 5 weight %, wherein the solid content can also be higher or lower and generally range between 10 weight %. It has to be taken into account, however, that, on the one hand, solids such as zeolites (and phyllosilicates and their derivates, resp.) have an average particle size which grows during stirring into a liquid lotion due to agglomeration, but that, on the other hand, the dispersion (solid in liquid phase) is applied to the carrier material 4 (such as polypropylene or polyethylene) in a further step through lines of a moistening device such as a moistening rod 5 (see below), wherein the diameter (i in the case of circular openings or the gap width 6 (i.e., in transversal direction) in the case of oblong openings should be kept as small as possible to obtain a good result in view of pump performance this, however, results in blockage of the openings due to the agglomeration of the zeolites such that mass production does not appear to be possible. For this reason, agglomerating solids are not used for the production of wet wipes. (This problem does not arise in the production of common powder laundry detergents where zeolites are replaced by tensides.)

According to the invention, the problem above, that agglomeration is opposed to a small opening gap width 6, was solved by physically controlling the cinetics of agglomeration: On the one hand, a dispergator for distributing the particles 2 in a tine manner inside the lotion 1 was used for the first time. The fine distribution in the dispersion 3 was further supported by using particles as small as possible. The ratio between the size of the particles 2 and the diameter 6 of a circular opening and the gap width 6 of an oblong opening, resp., of the moistening rod has appeared to be crucial for the production of the inventive three-phase heavy-duty laundry detergent wipe. Investigations have revealed that an advantegous ratio ranges between 5*10⁴:1 and 15*10⁴:1 (e.g. with a average size of the particles 2 between 1 μm and 3 μm at a diameter and a gap width, resp., 6 of the openings of the moistening rod 5 of 2 mm), wherein a particularly advantageous ratio was 8.5*10⁻⁴:1 (e.g. with a average size of the particles 2 between 1.7 μm at a diameter and a gap width, resp., 6 of the openings of the moistening rod 5 of 2 mm).

After adding the solids 2 the dispersion 3 has a solid content of 1-10 weight % such as, e.g., a solid content of 5 weight %. In a third step, this dispersion is applied by means of a moistening device 5 to a carrier material which is then folded and cut.

A hydrophobic material in the form of a continuous filament has revealed to be suitable for the carrier material 4, in particular polypropylene and polyethylene.

These materials can be processed in the form of a continuous filament, whereby the object not to let polymers intrude the groundwater is satisfied (no dissolution, no micro particles). Furthermore, due to the fact that the consumer removes the carrier material after washing, the carrier material satisfies the criteria of supplying it to the plastic/packaging waste (e.g., Green Dot (“Gruener Punkt”)). Thus, this non-washing active portion can entirely be recycled to the resource cycle.

Taking into account the sustainability features explained above, the product definition of the three-phase heavy-duty laundry detergent wipe corresponds to the composition according to Table 4 which is particularly suitable for the manufacturing.

TABLE 4
Composition of a highly active three-phase heavy-duty laundry
detergent wipe (weight %)

| Feature | Dimensions |
|---|---|
| Carrier material | 100 gsm polypropylene fiber (continuous filament) |
| Wipe dimensions | 220 × 250 mm |
| Lotion | 10-30% water |
| Solid content | 5.00% |
| Amount dispersion/ | 23 g |
| suspension per wipe | |

Taking into account the laundry product forms known so far, the comparisons of the non-washing active components which are added to the environment with use (via the washing water) and their masses, resp., are shown in Tables 5 and 6, resp.

TABLE 5
Average addition of non-washing components in weight %

| | Powder | Liquid | Pouch | Laundry sheet | Three-phase wipe |
|---|---|---|---|---|---|
| Filler/trickling medium | 20% | — | — | — | — |
| (e.g. Na₂SO₄) | | | | | |
| Water | — | 50% | — | — | 10-30% |
| Solutizer | — | — | 15% | — | — |
| Polymer | — | — | 10% | — | (resource cycle) |
| Molding material | — | — | — | 50% | — |
| (e.g. fatty alcohols) | | | | | |
| Sum of non-washing | 20% | 50% | 25% | 50% | 10-30% |
| active components | | | | | |

TABLE 6
Average mass of laundry detergent forms per washing load

| | Powder | Liquid | Pouch | Laundry sheet | Three-phase wipe |
|---|---|---|---|---|---|
| Mass | 80 | 75 | 37.5 | 25 | 28.5 |
| (g) | | | | | |

The use of resources by non-washing active components depending on the application form resulting therefrom is shown cumulated in Table 7.

TABLE 7
Cumulated use of resources by non-washing active components

| | | | | Laundry | Three-phase |
|---|---|---|---|---|---|
| | Powder | Liquid | Pouch | sheet | wipe |
| Mass (g) | 16 | 37.5 | 9.4 | 12.5 | 5.7 |
| Comparison normed | 2.81 | 6.58 | 1.65 | 2.19 | 1.0 |

With the cold production of the three-phase heavy-duty laundry detergent wipe, as well as the avoidance of overdosing due to pre-dosage, all objects in regard to sustainability could be achieved.

1. A method for manufacturing a three-phase heavy-duty laundry detergent wipe, wherein a dispersion is applied to carrier material which is solid at ambient temperature, the method comprising:
(a) providing a liquid laundry detergent lotion with exothermically saponified components and a water content of 10-30% by weight;
(b) adding solid additives to the liquid laundry detergent lotion using a disperser such that the dispersion is created with a solid content of 1-10% by weight; and
(c) applying the dispersion to the carrier material with a moistening device having openings therein such that the carrier material statistically fixes the dispersion;
wherein steps (a)-(c) are performed at ambient temperature; and
wherein a ratio between an average particle size of the solid additives and a diameter and gap width, respectively, of the openings of the moistening device ranges between 5*10″⁴:1 and 15*10⁻⁴:1.

2. The method according to claim 1, wherein the solid additives are zeolites, phyllosilicates and/or derivates thereof.

3. according to claim 1, wherein the water content of the liquid laundry detergent lotion is approximately 25% by weight.

4. The method according to claim 1, wherein the solid content of the dispersion is approximately 5% by weight.

5. The method according to claim 1, wherein the ratio between the average particle size of the solid additives and the diameter and gap width, respectively, of the openings of the moistening device is approx. 8.5*10⁻⁴:1.

6. The method according to claim 5, wherein the average particle size is 1.7 μm and the gap width is 2 mm.

7. The method according to claim 1, wherein the carrier material comprises a hydrophobic continuous filament.

8. The method according to claim 7, wherein the hydrophobic continuous filament comprises polypropylene or polyethylene.

9. The method according to claim 1, wherein the dispersion contains all known components of a heavy-duty laundry detergent.

10. A three-phase, heavy-duty laundry detergent wipe, comprising:
a carrier material that is solid at ambient temperature and to which a dispersion comprising of a liquid laundry detergent lotion and solid additives has been applied,
wherein the lotion contains exothermically saponified components and has a water content of 10-30% by weight,
wherein the solid content of the dispersion is 1-10% by weight, and
wherein the average particle size of the solid additives ranges between 1 μm and 3 μm.

11. The three-phase heavy-duty laundry detergent wipe according to claim 10, wherein the solid additives are zeolites, phyllosilicates and/or derivates thereof.

12. The three-phase heavy-duty laundry detergent wipe according to claim 10, wherein the water content of the liquid laundry detergent lotion is approximately 25% by weight.

13. The three-phase heavy-duty laundry detergent wipe according to claim 10, wherein the solid content of the dispersion is approximately 5% by weight.

14. The three-phase heavy-duty laundry detergent wipe according to claim 10, wherein the average particle size of the solid additives is 1.7 μm.

15. The three-phase heavy-duty laundry detergent wipe according to claim 10, wherein the carrier material comprises a hydrophobic continuous filament.

16. The three-phase heavy-duty laundry detergent wipe according to claim 15, the hydrophobic continuous filament comprises polypropylene or polyethylene.

17. The three-phase heavy-duty laundry detergent wipe according to claim 10, wherein the dispersion contains all known components of a heavy-duty laundry detergent.

18. A system, comprising:
a wipe; and
a moistening device having openings for the passage of a dispersion,
wherein the moistening device is configured for applying a dispersion comprising a liquid laundry detergent lotion and solid additives to a carrier material of the wipe,
wherein the lotion contains exothermically saponified components and has a water content of 10-30% by weight,
wherein the solid content of the dispersion is 1-10% by weight, and
wherein the ratio between an average particle size of the solid additives and a diameter and gap width, respectively, of the openings of the moistening device ranges between 5*10⁴:1 and 15*10⁴:1.

19. System The system according to claim 18, wherein the solid additives are zeolites, phyllosilicates and/or their derivates.
